(19) United States
(12) Patent Application Publication
(10) Pub. No.: US 2008/0014067 A1
(43) Pub. Date: Jan. 17, 2008

(54) CARGO CARRIER

(76) Inventor: Richard A. Calder, Marion, SC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 11/163,074

(22) Filed: Oct. 4, 2005

(51) Int. Cl. B60P 1/64

(52) U.S. Cl. 414/500

(57) ABSTRACT

A cargo carrier includes at least one rail and a sled. The sled slidably engages the rail. One end of rail has a downward sloping portion. When the sled slides along the rail the sled will tilt when the rollers engages the sloping portion of the rail. While in the tilted position, cargo can be unloaded from the sled.

### BACKGROUND OF THE INVENTION

The present invention relates generally to the art of devices for transporting cargo using a vehicle.

It is well known to haul cargo using an apparatus attached to a vehicle. For example, trailers are often towed behind the vehicle to transport a boat or other cargo. The use of trailers, however, generally requires that the driver exhibit greater skill when driving the vehicle. In addition, trailers may pose visibility problems and increase the space needed to park the vehicle.

It is also well known to haul cargo in the bed of a pickup truck. Depending on the size and weight of the cargo, it will be appreciated that loading and unloading may be difficult. Furthermore, when hauling cargo in the bed of a vehicle, adequately securing the cargo may be an issue.

### SUMMARY

The present invention recognizes and addresses the foregoing considerations, and others, of prior art construction and methods. Accordingly, it is an object of the present invention to provide an improved carrier for transporting cargo in the rear of a vehicle.

This and other objects are achieved by a carrier for transporting cargo in the rear of a vehicle. The carrier includes a frame situated at least partially within the perimeter of a vehicle. The frame is comprised of at least one rail having a first end portion and a second end portion with the second end portion having a downward slope. The frame extends beyond the perimeter of the vehicle. The carrier also includes a sled that slidably engages the frame. When the sled slides toward the second end portion of the rail, the vertical distance is sufficient to allow the sled to tilt relative to an initial position of the sled.

In another embodiment, an upper carrier is secured to the lower frame. The upper carrier is comprised of an upper sled mounted with rollers that are slidably engaged to an upper frame. The upper frame is at least partially within the rear of the vehicle. The upper frame is comprised of at least one rail having a first and a second end with a downward sloping portion at the second end thereof. The rail has a channel to receive the upper sled's plurality of rollers. The second end portion of the upper rail sits at a vertical distance below the upper rail's first end portion. This vertical distance is sufficient to allow the upper sled to tilt relative to an initial position of the upper sled within the rear of the vehicle when the upper sled slidably engages the upper rail's second end potion.

The accompanying drawings, which are incorporated in and constitute a part of this specification, illustrate one or more embodiments of the invention and, together with the description, serve to explain the principles of the invention

### DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a perspective view of a carrier in accordance with an embodiment of the present invention;

FIG. 2A is a side elevation of the carrier of FIG. 1 mounted in the bed of a pickup truck;

FIGS. 2B and 2C are views similar to FIG. 2A but showing the cargo at various stages of being unloaded;

FIG. 3 is a section view taken along line 3-3 of FIG. 2C;

FIG. 4 is a view taken along line 4-4 of FIG. 2C; and

FIG. 5 is a perspective view of a multiple carrier in accordance with another embodiment of the present invention.

Repeat use of reference characters in the present specification and drawings is intended to represent same or analogous features or elements of the invention.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

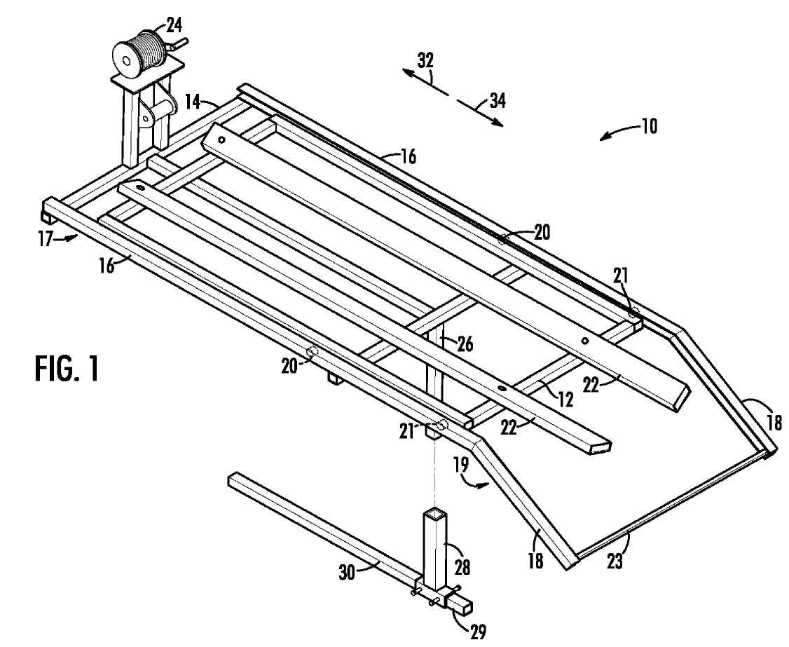

FIG. 1 illustrates a cargo carrier 10 constructed in accordance with an embodiment of the present invention. Cargo carrier 10 may be used with any type of suitable vehicle, such as a truck or a trailer. That is, the term “vehicle” will be used to describe both motorized vehicles (such as cars and trucks) and hitched trailers into which the carrier might be mounted.

Carrier 10 generally includes a sled 12 mounted for slidable movement with respect to a frame 14. Frame 14 includes at least one rail 16 having a first end portion 17 and a second end portion 19. In the illustrated embodiment, for example, a pair of parallel rails 16 are provided. As can be seen, second end portion 19 of the rails 16 slopes downward, as indicated at 18, to a location which is at a vertical distance below first end portion 17. In some embodiments, second end portion 19 may be detachable. This would permit the tailgate to be latched in its upright position if the carrier is located in the bed of a truck.

As will be explained more fully below, carrier 10 may also include suitable sliding elements to facilitate sliding movement between sled 12 and frame 14. For example, the illustrated embodiment includes a plurality of forward rollers 20 and rearward rollers 21 attached to sled 12 as shown. In this case, carrier 10 is adapted to transport a small boat. Accordingly, sled 12 includes a pair of runners 22 of the type typically used on boat trailers. Carrier 10 further includes a pulling device, such as a winch 24, mounted on frame 14 near first end portion 17 of rails 16. As one skilled in the art will appreciate, winch 24 may be a hand winch, an electric winch, a remotely controlled electric winch, or other suitable device.

The carrier may be constructed of steel, stainless steel, aluminum, titanium or any other suitable material. The components of the carrier can be welded, bolted, screwed, riveted, glued or otherwise fastened using sound engineering judgment. The sled and frame can also be further modified to meet the requirements of differing loads. For example, the sled and frame may be structurally reinforced to accommodate heavier loads.

Other modifications may be made to sled 12 depending on the type of cargo to be carried. For example, a platform may be attached to the sled to accommodate cargo, such as ATVs or lawnmowers, that may be more suitably carried on a platform. Other modifications may be made to sled 12 in order to accommodate personal watercraft, motorcycles or the like. Alternatively, the sled may be equipped with a container to transport and dump cargo such as firewood, gravel, bricks, dirt, or other bulk materials.

As will be apparent to those skilled in the art, additional modifications can be made to the cargo carrier. For instance, to assist in storing the cargo carrier, folding legs or stands can be added to the frame. While being stored on the legs or stands, a platform can be added to the sled to create a work bench. Additionally, wheels can be added to the first end portion 17 and rubber grommets added to rail 16 to assist in the loading and unloading of the carrier from a vehicle. The wheels would allow the carrier to slide in and out of the vehicle.

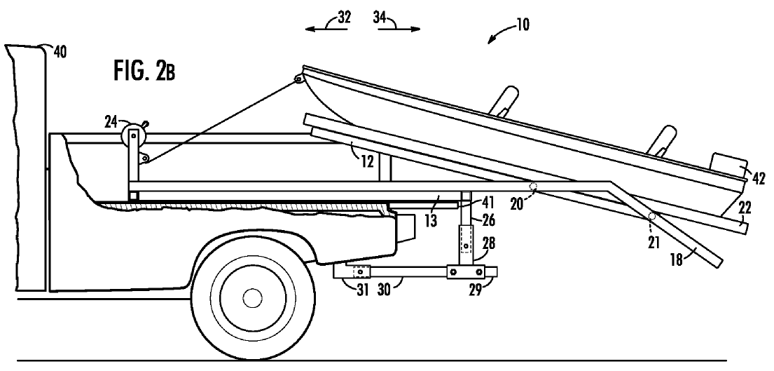

With reference now to FIGS. 1 and 3, rails 16 are each configured in this embodiment having a channel in which rollers 20 and 21 are received. In this case, the respective channels of each rail 16 are directed inwardly, such that they face one another. This configuration captures rollers 20 and 21 to permit sliding movement of sled 12 in a first direction 32 or a second direction 34.

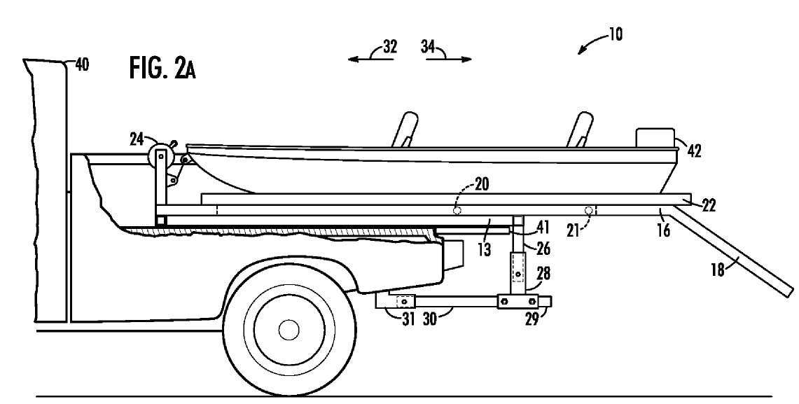

FIG. 2A illustrates the sled's initial position when ready for transit. As the sled is rolled in second direction 34, it will leave the initial position and rearward rollers 21 will enter the downward slope of end portion 19. As shown in FIG. 2B, sled 12 tilts relative to its initial position when rearward rollers 21 enter this downward slope. As will be apparent to one skilled in the art, this tilting assists in removing cargo from sled 12. When sled 12 is moved in direction 32, it will resume the initial position in which the cargo is preferably transported.

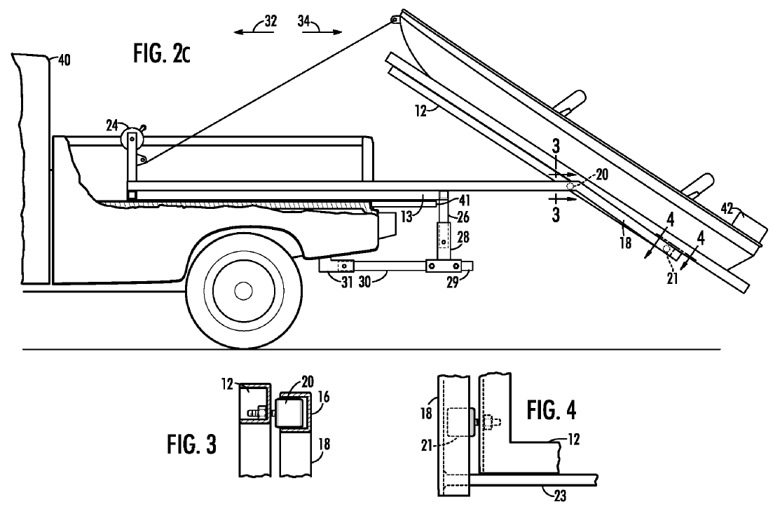

With reference now to FIGS. 2A-2C, carrier 10 is positioned in the bed of a truck 40. As shown, frame 14 extends beyond a perimeter 41 of truck 40. In this embodiment, the cargo is a boat 42 supported on runners 22. As shown in FIG. 2B, when sled 12 moves in second direction 34, rearward rollers 21 enter the downward slope of end portion 19. This sliding movement in second direction 34 causes sled 12 to tilt relative to its initial position. As shown in FIG. 2C, when sled 12 moves farther in second direction 34, the tilt relative to the initial position increases, allowing for the cargo to be easily removed from carrier 10. As shown in FIG. 4, a bar 23 or other suitable stop may be provided to impede sled 12 from sliding completely out of frame 14.

One skilled in the art will appreciate that carrier 10 permits boat 42 to be launched directly into a body of water. To launch the boat, the bed of truck 40 would be positioned near the body of water. Winch 24 is utilized to lower boat 42 toward the body of water. As winch 24 releases the cable attached to boat 42, sled 12 travels in second direction 34. When sled 12 engages the downward slope of end portion 19, sled 12 and boat 42 would both tilt towards the body of water. Boat 42 then slides off runners 22 and launches into the body of water.

In some embodiments, the mounting location of rollers 20, 21 to sled 12 may be adjusted to allow the launching of boat 42 into low water or off a cliff bank. This adjustment may include mounting rollers 20, 21 such that there is a greater distance between rearward rollers 21 and the rear of sled 12 than shown in the Figures. Optionally, bar 23 may be mounted to the underside of downward sloping portion 19 in such an embodiment, thereby allowing the rear of sled 12 to slidably exit downward sloping portion 19 when rolled in second direction 34. Roller stops may be mounted in downward sloping portion 19 to keep rearward rollers 21 from exiting downward sloping portion 19.

FIGS. 2A-2C and 4 illustrate one preferred manner by which carrier 10 may be attached to a vehicle. In this case, carrier 10 is secured to truck 40 by post 26 extending downward from frame 14. Post 26 is received by connector 28 positioned on beam 30. Preferably, connector 28 is slidably positionable along beam 30 and can be securely fixed when connector 28 is positioned to receive post 26. As shown, beam 30 is preferably configured for receipt by vehicle hitch 31. The distance that frame 14 extends beyond the rear of the vehicle may depend on the size of the vehicle used. By allowing connector 28 to be fixed to beam 30 in multiple positions, carrier 10 may accommodate vehicles of varying sizes. A distal end 29 of post 30 may also be configured to serve as a trailer receiver hitch since receiver hitch 31 is already being used. Thus, if carrier 10 is positioned in the bed of a truck, a trailer could be attached to distal end 29 and towed behind the truck. Alternatively, a hitch rack could be attached to distal end 29. Coolers, bicycles, tackle boxes or other cargo could be transported on such a rack.

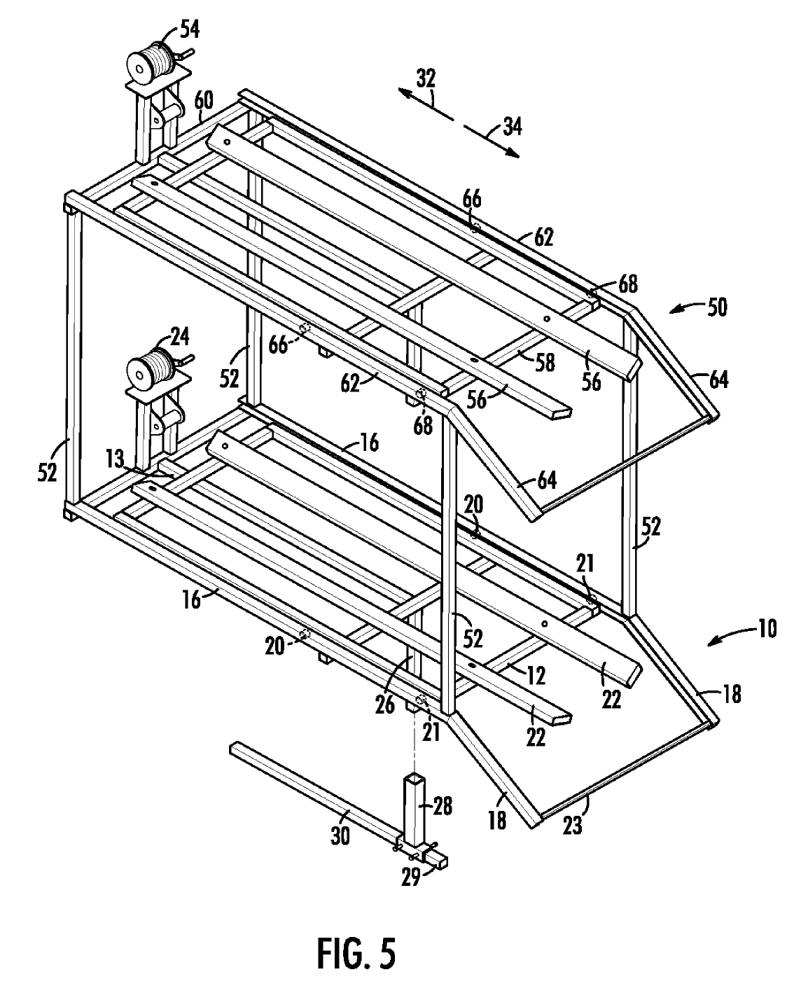

With reference now to FIG. 5, this embodiment of the carrier includes an upper carrier 50 mounted to carrier 10. Upper carrier 50 is supported by a plurality of legs 52. Legs 52 are of a length to enable cargo to be carried below on sled 12. The length of legs 52 may vary based on the type of cargo carried by the carrier. Upper carrier 50 includes an upper sled 58, an upper frame 60, upper rails 62, and a downward sloping portion 64. Optionally, the downward sloping portion 64 may be detachable. A plurality of forward rollers 66 and rearward rollers 68 are attached to upper sled 58. Runners 56 or another suitable cargo support feature can be attached to upper sled 58. Upper carrier 50 functions substantially in the same way as carrier 10.

In one embodiment, two boats can be transported simultaneously while transporting one boat on sled 12 and another boat on upper sled 58. To unload the boat on sled 12, both sleds 12, 58 can be moved in direction 34 until both sleds 12, 58 tilt. The boat on sled 12 can then be unloaded while the boat in upper carrier 50 is in the tilted position.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the literal and equivalent scope of the appended claims.

What is claimed is:

1. A carrier for transporting cargo in the perimeter of a vehicle, said carrier comprising:
a frame situated at least partially within the perimeter of a vehicle, said frame including at least one rail having a first end portion and a second end portion, the second end portion having a downward slope;
said frame being configured to extend beyond the perimeter of the vehicle;
a sled slidably engaging the frame; and
wherein the second end portion of the at least one rail extends to a position located a vertical distance below the first end portion thereof, the vertical distance being sufficient to allow the sled to tilt relative to an initial position of the sled when the sled reaches the downward slope of said second end portion.

2. The carrier of claim 1 wherein the at least one rail of the frame defines a channel in which at least one sliding element of the sled is received.

3. The carrier of claim 2 wherein the at least one sliding element comprises a plurality of rollers.

4. The carrier of claim 2 wherein said at least one rail comprises a pair of parallel rails.

5. The carrier of claim 4 wherein respective channels of said parallel rails are situated to face each other.

6. The carrier of claim 1 wherein the frame is positioned in a truck bed.

7. The carrier of claim 1 wherein the frame is positioned in a trailer.

8. The carrier of claim 1 wherein a lifting device is mounted to the frame.

9. The carrier of claim 8 wherein the lifting device is a winch.

10. The carrier of claim 9 wherein the winch is a hand operated winch.

11. The carrier of claim 1 further comprising a hitch assembly, said hitch assembly being further comprised of:
a first post secured to the frame and extending downward;
a beam having a first end and a second end wherein the first end is received into a vehicle's hitch; and
a connector that receives the first post, wherein the connector is selectably positionable along the beam.

12. The carrier of claim 11 further comprising a receiver hitch positioned at the second end of the beam.

13. The carrier of claim 1 further comprising at least one runner attached to the sled.

14. The carrier of claim 1 further comprising a platform attached to the sled.

15. The carrier of claim 2, wherein the sled further comprises:
a first roller mounted to the sled;
a second roller mounted to the sled; and
wherein the distance between the first roller and the second roller measured along an axis parallel to the centerline of the vehicle is greater than the length of the rail's downward sloping portion.

16. The carrier of claim 1 wherein the downward sloping portion of the rail is detachable from the remainder of the rail.

17. The carrier of claim 2 further comprising an upper carrier, the upper carrier being further comprised of:
an upper sled having a plurality of rollers mounted thereto;
an upper frame at least partially within the rear of the vehicle, wherein the upper frame receives the upper sled's plurality of rollers, the upper frame being comprised of at least one upper rail having a first end portion, a second end portion, and a channel to receive the upper sled's plurality of rollers, wherein the second end portion of said at least one upper rail has a downward slope;
wherein the upper sled is configured to roll in the upper frame with the plurality of rollers slidably engaging the channel;
wherein the upper frame extends beyond the perimeter of the vehicle;
wherein the second end portion of the at least one upper rail sits at a vertical distance below the upper rail's first end, the vertical distance being sufficient to allow the upper sled to tilt relative to an initial position of the upper sled within the rear of the vehicle when the upper sled slidably engages the upper rail's second end portion; and
wherein the upper frame is secured to the lower frame.

18. The carrier of claim 1 7 wherein an upper lifting device is mounted proximate the first end of the at least one upper rail.

19. A carrier for transporting cargo in the perimeter of a vehicle, said carrier comprising:
a frame situated at least partially within the perimeter of a vehicle, said frame including at least one rail having a first end portion and a second end portion, the second end portion having a downward slope;
said frame being configured to extend beyond the perimeter of the vehicle;
a sled slidably engaging the frame;
wherein the second end portion of the at least one rail extends to a position located a vertical distance below the first end portion thereof, the vertical distance being sufficient to allow the sled to tilt relative to an initial position of the sled when the sled reaches the downward slope of said second end portion;
wherein the carrier further comprising a hitch assembly, said hitch assembly being further comprised of:
a first post secured to the frame and extending downward;
beam having a first end and a second end wherein the first end is received into a vehicle's hitch; and
a connector that receives the first post, wherein the connector is selectably positionable along the beam.

20. The carrier of claim 19 further comprising an upper carrier, the upper carrier comprising:
an upper sled having a plurality of rollers mounted thereto;
an upper frame at least partially within the rear of the vehicle, wherein the upper frame receives the upper sled's plurality of rollers, the upper frame being comprised of at least one upper rail having a first end portion, a second end portion, and a channel to receive the upper sled's plurality of rollers, wherein the second end portion of said at least one upper rail has a downward slope;
wherein the upper sled is configured to roll in the upper frame with the plurality of rollers slidably engaging the channel;
wherein the upper frame extends beyond the perimeter of the vehicle;
wherein the second end portion of the at least one upper rail sits at a vertical distance below the upper rail's first end, the vertical distance being sufficient to allow the upper sled to tilt relative to an initial position of the upper sled within the rear of the vehicle when the upper sled slidably engages the upper rail's second end portion; and
wherein the upper frame is secured to the lower frame.

21. The carrier of claim 20 wherein an upper lifting device is mounted proximate the first end of the at least one upper rail.

22. A carrier for transporting cargo in the rear of a vehicle, said carrier comprising:
a frame situated at least partially within the perimeter of a vehicle, said frame including at least one rail having a first end portion and a second end portion, the second end portion having a downward slope;
said frame being configured to extend beyond the perimeter of the vehicle;
a sled slidably engaging the frame;
wherein the second end portion of the at least one rail extends to a position located a vertical distance below the first end portion thereof, the vertical distance being sufficient to allow the sled to tilt relative to an initial position of the sled when the sled reaches the downward slope of said second end portion; and
wherein at least one runner is attached to the sled.
